(19) United States
(12) Patent Application Publication
(10) Pub. No.: US 2016/0225248 A1
(43) Pub. Date: Aug. 4, 2016

(54) UNDERGROUND DATA COMMUNICATION APPARATUS, SYSTEM, AND METHOD

(71) Applicant: 3M INNOVATIVE PROPERTIES COMPANY, Saint Paul, MN (US)

(72) Inventors: Ernesto M. Rodriguez, Jr., Austin, TX (US); Vaughn G. Amann, Austin, TX (US); Lars Schrix, Duisburg (DE); Jens Weichold, Erkelenz (DE); Anne-Maud B. Laprais, Paris (FR)

(21) Appl. No.: 15/021,965

(22) PCT Filed: Sep. 10, 2014
(86) PCT No.: PCT/US14/54905

§ 371 Date: Mar. 15, 2016

Related U.S. Application Data
(60) Provisional application No. 61/879,415, filed on Sep. 18, 2013.
(60) Provisional application No. 62/014,764, filed on Jun. 20, 2014.

(51) Int. Cl. G08B 21/18; H04L 29/06; H04L 29/08; H04B 13/02; H04B 3/46; H04B 1/38; H04L 12/931

(52) U.S. Cl. CPC G08B 21/185; H04B 1/38; H04L 65/102; H04L 49/351; H04B 13/02; H04B 3/46; H04L 67/12

(57) ABSTRACT

An underground data communication apparatus, system, and method are described. The data communication system includes a transceiver disposed on an entrance port to an underground vault or enclosure, where the transceiver includes a rugged housing, where at least a portion of the rugged housing extends above the surface of the entrance port. A monitoring device is disposed in the vault. The monitoring device can be a sensor that provides data related to a real-time condition within the vault. In addition, the data communication system includes a gateway unit that relays the data to the transceiver. The gateway/transceiver can take a combination of wireless and/or wired signals from the monitoring device which provides real-time data regarding environmental, component, and/or other electronic equipment conditions for those components/equipment disposed within the vault.

### BACKGROUND

Machine to machine communication is becoming increasingly important to the energy, communications, and security markets, among others. Supervisory Control and Data Acquisition (SCADA) systems used in those industries rely on inputs from remotely located sensors to function properly. SCADA systems can also output signals to actuate remote equipment in the field. A sizeable portion of that equipment (˜18% for U.S. electric utilities) is located underground, and providing wireless communications between above ground and underground equipment is a serious challenge.

Current methods used to locate underground cable faults are still slow and labor intensive. Even relatively short outages can be used against utilities and lead to rate adjustments for customers, so a faster means of locating and fixing underground faults is needed.

Thus, there is a need for communicating wireless signals into and out of underground equipment vaults and other structures where underground equipment is located.

### SUMMARY OF THE INVENTION

In one aspect of the invention, an underground data communication system includes a transceiver disposed on an entrance port to an underground vault or enclosure, where the transceiver includes a rugged housing, where at least a portion of the rugged housing extends above the surface of the entrance port. A monitoring device is disposed in the vault. The monitoring device can be a sensor that provides data related to a real-time condition within the vault. In addition, the data communication system includes a gateway unit that relays the data to the transceiver.

In another aspect, the monitoring device is coupled to the gateway unit via communication cables.

In another aspect, the monitoring device communicates with the gateway unit wirelessly.

In another aspect, the monitoring device comprises a sensor. In yet another aspect, the gateway unit gathers data from a plurality of sensors. In a further aspect, the sensor comprises at least one of the following sensors: power, voltage, current, temperature, combustible materials or byproducts of combustion, mechanical strain, mechanical movement, humidity, soil condition, pressure, hazardous atmosphere, liquid flow, leakage, component end-of-life or lifetime, personnel presence, physical state, light level, and vibration.

In another aspect, the sensor is incorporated in a sensored termination device and is configured to monitor a condition of a power cable. In an alternative aspect, the sensor is incorporated in a sensored splice device is configured to monitor a condition of a power cable.

In another aspect, the underground data communication system further comprises a remote terminal unit (RTU) that receives a signal from the monitoring device. In yet another aspect, the RTU includes a wireless network transmitter/receiver. In a further aspect, the gateway unit is disposed in the RTU.

In another aspect, the gateway unit is disposed in the transceiver unit.

In another aspect, the transceiver unit includes multiple antennas and radios.

In another aspect, the transceiver unit includes a dual housing that includes an upper body portion and a lower body portion, wherein the upper body portion houses a first antenna portion and a first radio portion, and the lower body portion houses a second antenna portion and a second radio portion.

In another aspect, the gateway unit performs local analysis and interpretation of data from the monitoring devices. In yet another aspect, the gateway unit interprets monitoring device information to determine at least one of the following environmental conditions: presence of a hazardous gas, moisture, dust, chemical composition, corrosion, and pest presence. In yet a further aspect, the gateway unit is configured to perform a local action. In another aspect, the local action comprises opening or closing of a switch.

In another aspect, the gateway unit is configured to send aggregated information upstream to another aggregation node or cloud server above ground. In yet another aspect, the aggregated data comprises one or more of periodic status notification and asynchronous alarm notification.

In another aspect, the gateway unit is configured to respond to messages sent to it by an upstream aggregation node or cloud.

In another aspect, the entrance port comprises a manhole cover. In a further aspect, the gateway unit is secured to the manhole cover via a screw-on type conduit that can be screwed into an appropriately-sized hole tapped into the manhole cover.

In another aspect, the underground data communication system is configured to communicate wirelessly with a second monitoring device that is located underground, outside of the vault.

In another aspect, the first underground data communication system is located at a first vault, further comprising a second underground data communication system located at a second vault, wherein the second underground data communication system communicates via LAN communication with the first underground data communication system.

In another aspect of the invention, a method of providing condition information about an underground vault, comprises providing a transceiver disposed on an entrance port to the underground vault, the transceiver including a rugged housing, at least a portion of the rugged housing extending above the surface of the entrance port, sending a LAN data packet corresponding to a vault condition from a monitoring device located within the vault, receiving and processing the LAN data packet, generating a WAN data packet corresponding to either the LAN data packet or the processing of the LAN data packet, and sending the WAN data packet to an entity outside of the vault.

In another aspect, an active sensor located in the underground vault takes a measurement of a vault condition to generate measurement data, wherein the measurement signal is processed to generate measured data. In a further aspect, the measured data is formatted into a measurement data packet, and the measurement data packet is encrypted and transmitted is sent as the LAN data packet. In a further aspect, a gateway unit decrypts the LAN data packet. In yet another aspect, the gateway unit interprets the decrypted LAN data packet.

In another aspect, the gateway unit determines whether or not to take a local action within the vault. In a further aspect, the gateway unit communicates a signal to equipment to take the local action. In yet another aspect, the gateway unit determines whether an upstream notification is required. In another aspect, the upstream notification is included in the WAN data packet.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The invention will be described hereinafter in part by reference to non-limiting examples thereof and with reference to the drawings, in which:

FIG. 1 is a schematic view of an underground data communication system according to a first aspect of the invention.

FIGS. 2A-2E are side views of alternative transceiver mountings and constructions according to other aspects of the invention.

FIG. 3 is a schematic view of an underground data communication system according to another aspect of the invention.

FIG. 4 is a flowchart of an example process for generating and communicating a data signal from an underground vault according to another aspect of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

An underground data communication apparatus, system, and method are described herein. The data communication system includes a transceiver disposed on an entrance port to an underground vault or enclosure, where the transceiver includes a rugged housing, where at least a portion of the rugged housing extends above the surface of the entrance port. A monitoring device is disposed in the vault. The monitoring device can be a sensor that provides data related to a real-time condition within the vault. In addition, the data communication system includes a gateway unit that relays the data to the transceiver.

In particular, in one aspect, the transceiver includes a physically robust antenna and radio. This antenna/transceiver can take a combination of wireless and wired signals from the monitoring device(s)/sensor(s) which provide real-time data regarding environmental, component, and other electronic equipment conditions for those components/equipment disposed within the vault. In addition, the communication system can communicate with other equipment and components disposed underground in other locations. The gateway unit relays the data payload from those monitoring devices/sensors and underground equipment to the transceiver which can communicate with above-ground network elements such as wireless access points, mobile radio cells, and private radios. As such, in some aspects, sensors can be used to provide real time information about underground grid performance, and a cost effective means for communicating with those monitoring devices/sensors is by using wireless networks.

The transceiver can be disposed or embedded in a raised structure. In another aspect, a matching pair of embedded raised structure antennas and/or electronics for above ground and below ground transmission respectively can be provided for a vault. In addition, multiple antennas (e.g., antennas transmitting/receiving WiFi, GPS, mobile radio, etc. signals) are provided in a single robust structure.

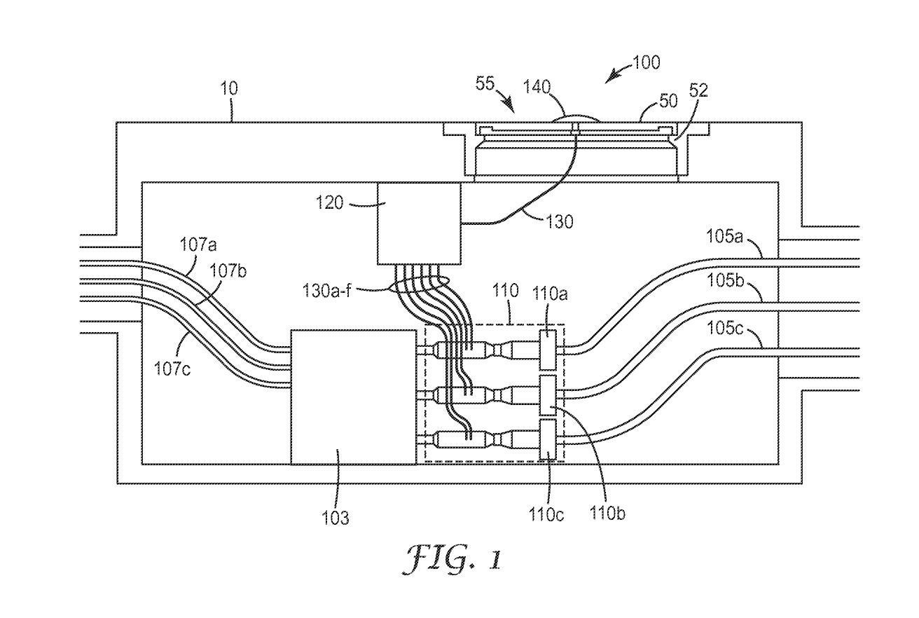

FIG. 1 shows one aspect of the present invention, an underground data communication system 100. The communications system 100 is disposed in an exemplary enclosure, here underground vault 10. In this example implementation, vault 10 includes a variety of equipment, such as one or more high voltage electrical lines, such as electrical lines 105a-105c (carrying e.g., medium to high voltage power), associated components and/or accessories, such as a splice or termination (in the example of FIG. 1, a termination 110 will represent such associated components and/or accessories), a transformer, such as a step down transformer 103, and further electrical lines 107a-107c (carrying low voltage power (e.g., 440V) to a nearby building or structure). In some vaults, a transformer may not be included therein.

The enclosure or vault 10 can be accessed from above ground via a portal, such as a conventional manhole cover 50, which can be formed from a metal or non-metal, and can have a conventional circular shape. In this aspect, vault 10 is can be constructed as a conventional underground vault, commonly used by electric, gas, water, and/or other utilities. However, in alternative aspects, the underground data communication system 100 can be utilized in a vault or similar structure, such as a basement, cellar, pit, shelter, pipe, or other underground enclosure.

The vault also includes at least one monitoring device disposed therein which can monitor a physical condition of the vault or of the components or equipment located in the vault. Such conditions would normally be difficult to gather or assess from above-ground. As described in detail below, the underground data communication system can provide a communication infrastructure to relay vault condition information to an above ground network of or SCADA, without having a service technician physically enter the vault to determine those conditions.

As shown in FIG. 1, in this example, termination 110 provides a terminal connection for a power cable, such as a medium or high voltage power cable 105a-105c. The monitoring device can be a sensor disposed on the termination. This sensor can provide sensing capabilities that measure a cable condition, such as voltage, current, and/or temperature. Thus, in this example, termination 110 can be referred to as a sensored termination 110 that can provide real-time data about the condition of one or more connected power lines.

For example, the sensored termination 110 of this aspect can include a Rogowski coil that produces a voltage that is proportional to the derivative of the current, meaning that an integrator can be utilized to revert back to a signal that is proportional to the current. Alternatively, a current sensor can be configured as a magnetic core current transformer that produces a current proportional to the current on the inner conductor. In addition, sensored termination 110 can include a capacitive voltage sensor that provides precise voltage measurements. Because sensored termination 110 can include both a current sensor and a capacitive voltage sensor, the sensored termination facilitates calculation of phase angle (power factor), Volt Amps (VA), Volt Amps reactive (VAr), and Watts (W). An exemplary sensored termination is described in U.S. Provisional Application No. 61/839,543, incorporated by reference herein in its entirety.

Thus, it is contemplated that the monitoring device can comprise one or more of the following sensors: power, voltage, current, temperature, combustible materials or byproducts of combustion, mechanical strain, mechanical movement (e.g. revolutions per minute), humidity, soil condition (acidity, moisture content, mineral content), pressure, hazardous atmosphere, liquid flow, leakage, component end-of-life or lifetime (e.g., a cathodic protection sensor), personnel presence (e.g., has someone entered the vault), physical state (e.g., is vault open or closed, is door open or closed, is a switch or valve open or closed, has item been tampered with), light sensor, vibration (seismic, tampering).

In another aspect of the invention, data is communicated from the monitoring device inside the vault to a network or SCADA located outside the vault. This communication can be accomplished via a gateway unit. As explained in further detail below, the gateway unit can be incorporated in a remote terminal unit, incorporated in a transceiver device mounted on the vault portal, or it can be implemented as a stand-alone unit within the vault or at the vault entrance.

The gateway unit can connect underground to various monitoring devices using wired or wireless connections. The gateway unit can perform local analysis and interpretation of data from the monitoring devices. For example, the gateway unit can interpret monitoring device/sensor information to determine environmental conditions such as the presence of hazardous gases, moisture, dust, chemical composition, corrosion, pest presence, and more. In addition, the gateway unit can perform some local actions, such as the opening and closing of switches. Further, the gateway unit can send aggregated information such as periodic status or asynchronous alarm notifications upstream to another aggregation node or cloud server above ground. The gateway unit can also respond to messages sent to it by an upstream aggregation node or cloud (e.g., SCADA) service. Typical commands from an upstream node or cloud service can include “transmit status,” perform action,” “set configuration parameter,” “load software,” etc.

As shown in FIG. 1, in this example, data from the sensored terminations 110a-110c can be communicated via one or more communication cables (here cables 130a-130f, with two cables connected to each sensored termination) to a remote terminal unit or RTU 120. The RTU 120 can be mounted at a central location within the vault 10, or along a wall or other internal vault structure. In this embodiment of the invention, RTU 120 can include a gateway unit (not separately shown). Alternatively, the gateway unit can be disposed within the transceiver 140 or configured as a stand-alone component. The gateway unit and transceiver are described in further detail below.

In one aspect, RTU 120 is adapted to process data signals received from sensored termination 110 and transform such data signals into signals useable in a supervisory control and data acquisition (SCADA) system. In addition, RTU 120 can also be adapted to receive signals from the SCADA system to control one or more components or equipment located in the vault. As shown in FIG. 1, data can be communicated between RTU 120 and a transceiver unit 140 (described below) via cable 130, which can comprise a conventional coaxial cable.

In another aspect of the invention, the RTU 120 can be implemented with a wireless network transmitter/receiver. Example wireless networks that can be used in an underground location include any combination of WiFi, ZigBee, ANT, Bluetooth, infrared, and others. Thus, RTU 120 can be configured to communicate wirelessly with transceiver 140 and/or the monitoring devices and/or equipment located in vault 10. This equipment can include sensored terminations or any of the other sensor types previously mentioned with added wireless communication capability.

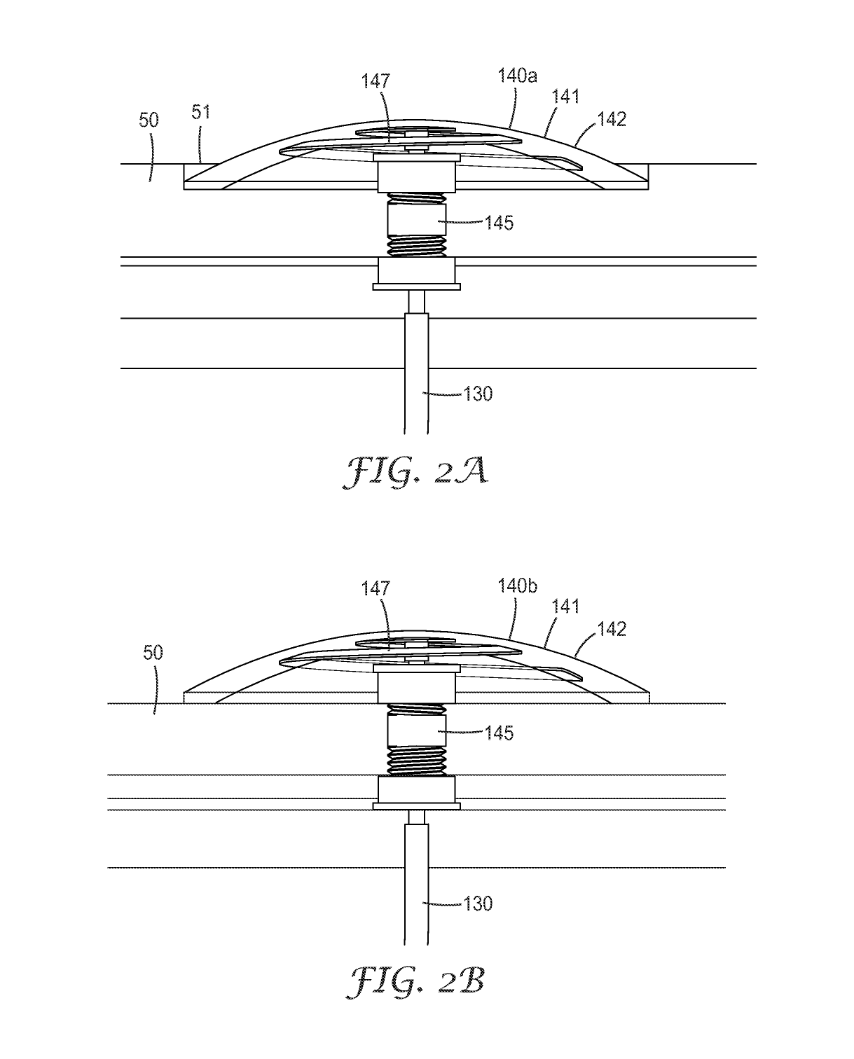

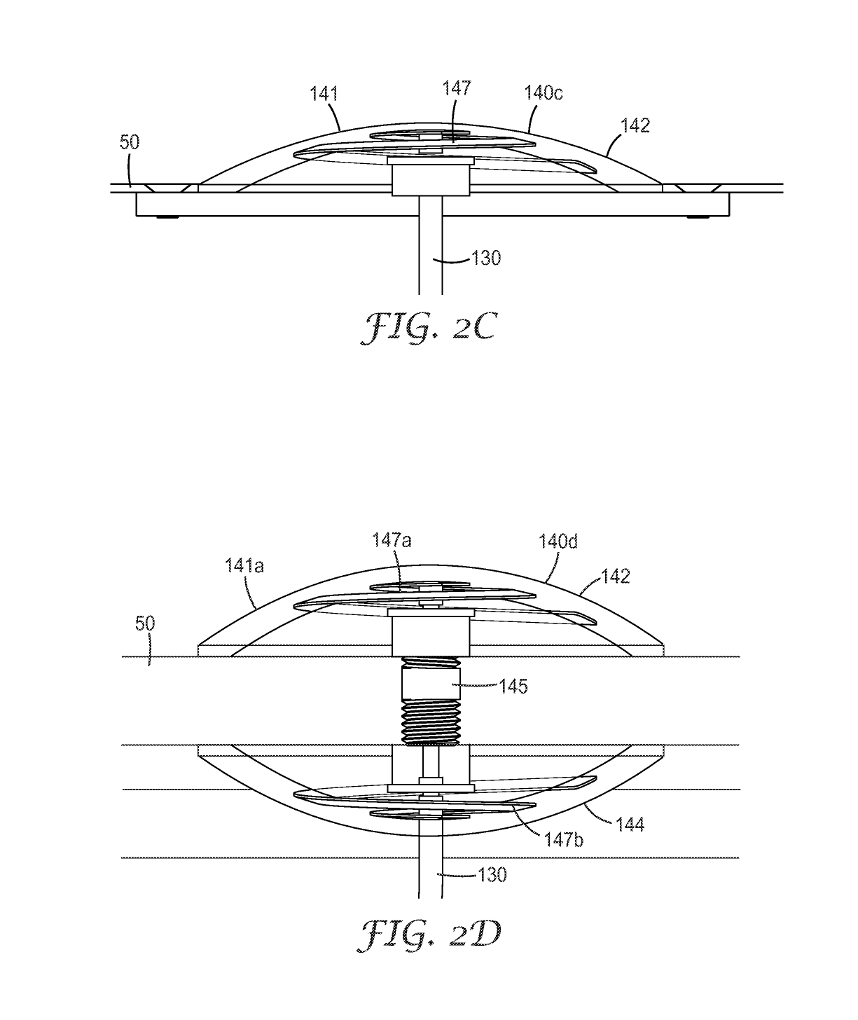

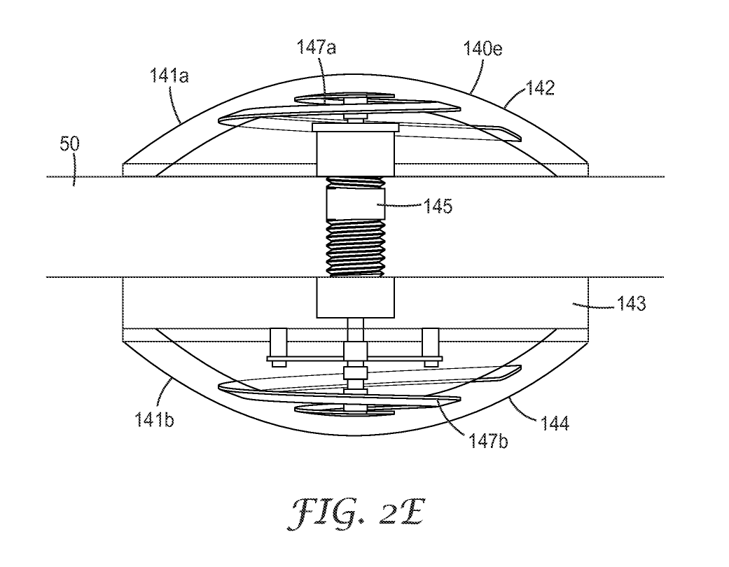

The communication system 100 further includes a transceiver unit 140 that communicates information from (and to) the sensored termination 110/RTU 120 to (and from) the above ground SCADA or wireless communications network. Several different transceiver unit constructions 140a-140e are shown in FIGS. 2A-2E and are described in further detail below.

It is noted that in an alternative aspect of the invention, the underground data communication system can omit the RTU altogether. In this manner, the transceiver unit 140 can provide a gateway unit that will allow the underground equipment/monitoring devices to communicate with above ground communications networks. In several aspects, the transceiver unit 140 comprises an environmentally hardened above ground antenna which is coupled to a radio which communicates with widely available above-ground wireless communications networks such as WiFi, WiMax, mobile telephone (3G, 4G), private licensed band, etc. The transceiver unit can also include a gateway unit comprising gateway electronics that provide an interface between above ground radio signals and communications to underground monitoring devices/equipment wirelessly via a second antenna or via direct connection to the gateway unit with copper and/or fiber cabling. The gateway unit performs network connection, security, and data translation functions between the above ground and underground networks.

As mentioned above, in one aspect, a single gateway unit can communicate with one or more of the multiple underground monitoring devices/equipment implemented within vault 10. As described above, the monitoring devices can comprise stand alone sensors or sensors integrated with equipment and components disposed in the vault, such as the sensor portion(s) of sensored terminations 110, and other vault sensors, such as moisture sensors, air quality sensors, pressure sensors, etc.

FIGS. 2A-2E show several different constructions for transceiver unit 140. For example, FIG. 2A shows a transceiver unit 140a having a housing 141 that includes a main body portion 142. An antenna portion 147 and a radio portion (which can include radio electronics, not shown) can be disposed in main body portion 142. In this configuration, transceiver unit 140a is mounted to manhole cover 50 that allows entrance into vault 10 from above the ground. In this aspect, manhole cover 50 can include a recessed portion 51 configured to support at least a base portion of the transceiver unit 140a. In one aspect, besides the radio and antenna components, the transceiver unit 140a may further include processors, data storage units, communications interfaces, power supplies, and human interface devices.

The housing 141 can be a sealed structure and may include one or more housing parts such as a cover and base plate. At least some of the housing parts may be made of a moldable plastic material. The material of the housing parts may be resistant against aggressive substances. The housing can be sealed to protect the radio, antenna, and other components contained within it. By using a seal of appropriate material, such as a graphite-containing material, a seal may additionally be provided against aggressive substances like gasoline or oil which may be present in an outside environment.

In an alternative aspect, housing 141 can be constructed as a radio frequency transparent pavement marker made of high impact resistant resin that can be molded, machined, or cast. An example alternative construction is described in U.S. Pat. No. 6,551,014, incorporated by reference herein in its entirety. In this alternative aspect, the reflectivity of the marker can be modified to visually indicate a state of the equipment in the vault. For example, a blinking or non-blinking light can indicates normal/abnormal status. Further, a slowly blinking marker light can indicate caution, and/or a fast blinking light can indicate a dangerous condition. In this example, a liquid crystal filter can be mounted in front of the reflector, and the LC polarity can be modulated with a microprocessor. Alternatively, the internal light source, e.g., and LED, can be directly modulated.

The electric or electronic components contained within the housing 141 can be active, passive, or both active and passive. Thus, the transceiver housing 141 makes it possible to mount an antenna on the outside surface of an underground vault or enclosure while allowing the radio/antenna to be electrically connected to, e.g., an RTU 120, located in the vault. For example, an antenna connection or conduit 145 can couple cable 130 to the transceiver unit 140a. In this aspect, cable 130 can be a conventional coaxial cable. The conduit 145 can have a screw-on construction and can screw into an appropriately-sized hole tapped into the manhole cover 50. In addition, the type of antenna design utilized can take into account the construction and materials used to form manhole cover 50. In a preferred aspect, manhole cover 50 comprises a standard, conventional manhole cover, as existing covers of various sizes and composition can be easily modified to fit the transceiver/antenna.

Thus, with this construction, if a monitoring device, such as a sensor portion of a sensored termination, senses a line fault, transceiver unit 140a can communicate real-time fault location information to a power utility network or SCADA system.

FIG. 2B shows an alternative aspect of the invention, a transceiver unit 140b having a housing 141 that includes a main body portion 142, where an antenna portion 147 and a radio portion can be disposed in main body portion 142. In this particular configuration, transceiver unit 140b is flush-mounted to manhole cover 50 and includes a robust, thick housing. For example, the housing can comprise a polycarbonate material with a polyurethane core, with a ribbed area that provides flexibility to keep the polycarbonate material from cracking.

An antenna connection or conduit 145 can couple cable 130 to the transceiver unit 140b. The interior components and operation of transceiver 140b can be the same as described above with respect to transceiver 140a.

FIG. 2C shows another alternative aspect of the invention, a transceiver unit 140c having a housing 141 that includes a main body portion 142, where an antenna portion 147 and a radio portion, along with accompanying electronics, can be disposed in main body portion 142. In this particular configuration, transceiver unit 140b is recessed-mounted to a thin manhole cover 50a and secured thereto via conventional bolts. An antenna connection or conduit 145 can couple cable 130 to the transceiver unit 140c. The interior components and operation of transceiver 140b can be the same as described above with respect to transceiver 140a.

FIG. 2D shows yet another alternative aspect of the invention, a transceiver unit 140d having a dual housing 141a, 141b that includes an upper body portion 142 and a lower body portion 144, where the upper body portion 142 houses a first antenna portion 147a and a radio portion, and the lower body portion 144 houses a second antenna portion 147b and a radio portion. The first antenna portion 147a can be configured to communicate with above-ground wireless networks and the second antenna portion 147b can be configured to communicate with a below-ground network via cable 130. In this particular configuration, upper body portion 142 is flush-mounted to first side of manhole cover 50 and lower body portion 144 is flush-mounted to a second side of manhole cover 50. This particular design allows for straightforward installation to an existing manhole cover by drilling a single hole and utilizing a screw-on type conduit 145 that can be screwed into the appropriately-sized hole tapped into the manhole cover 50. The housing 141a and be formed from a robust, thick housing material. The lower housing 141b can be formed from the same or a different material.

FIG. 2E shows yet another alternative aspect of the invention, a transceiver unit 140e having a dual housing 141a, 141b that includes an upper body portion 142 and a lower body portion 144, where the upper body portion 142 houses a first antenna portion 147a and a radio portion, and the lower body portion 144 houses a second antenna portion 147b and a radio portion. In addition, transceiver unit 140e further includes a gateway unit 143 that transforms the data from a first protocol (e.g., Zigbee, used below ground) to a second protocol e.g., 4G, used above ground). As such, the first antenna portion 147a can be configured to communicate with above-ground wireless networks and the second antenna portion 147b can be configured to communicate with a below-ground wireless network, which may be different from the above-ground wireless network. In this particular configuration, upper body portion 142 is flush-mounted to first side of manhole cover 50. The gateway unit 143, which can comprise a separate structure or can be contained within housing 141b, and lower body portion 144 can be flush-mounted to a second side of manhole cover 50. The gateway unit receives data from the monitoring device and can comprise appropriate circuits and or electronics to read the data, analyze the data, aggregate the data, classify the data, infer vault conditions based on the data, and take action based on the data. In addition, the gateway unit 143 can provide a clock source for event correlation.

Again, this particular design allows for straightforward installation to an existing manhole cover by drilling a single hole and utilizing a screw-on type conduit 145 that can be screwed into the appropriately-sized hole tapped into the manhole cover 50. The housing 141a and be formed from a robust, thick housing material. The lower housing 141b can be formed from the same or a different material.

In one aspect, an example structure that can be utilized to house at least some of the components of the transceiver and/or gateway unit is described in U.S. Pat. No. 8,135,352, incorporated by reference herein in its entirety.

In another aspect, multiple antennas can be embedded in the same housing (or housing portion) allowing for multiple communications methods both above and below ground. For example, WiFi and 4G antennas can be embedded in the same above ground antenna housing along with a GPS antenna to provide multiple network connections along with GPS positioning and timing information. A Bluetooth antenna can be embedded in the above ground housing to provide local communications to personnel in close proximity to the transceiver/gateway unit. For example, a craft person driving over a transceiver/gateway unit could directly read the sensors in the vault below using Bluetooth. An RFID antenna can be embedded in the above ground housing to permit reading underground sensor data with an RFID reader.

In another aspect, power can be provided to the components of the underground data communication system 100 through various means. In one aspect, equipment may be run via AC or DC power sources already located in the vault 10. If there is no available AC or DC power source, in another aspect, a power harvesting coil can be installed on electrical equipment, such as termination 110 that can provide power to the components in the vault 10. Alternatively, piezoelectric transducers can be utilized to convert the mechanical vibration found within vault 10 to electrical energy that can be stored in batteries or super capacitors. For example, a conventional piezoelectric transducer is available from Mide (www.mide.com). In another aspect, thermoelectric transducers can be utilized to convert the natural temperature differential between above ground and below ground to electrical energy. For example, see (http://www.idtechex.com/research/reports/thermoelectric-energy-harvesting-2012-2022-devices-applications-opportunities-000317.asp).

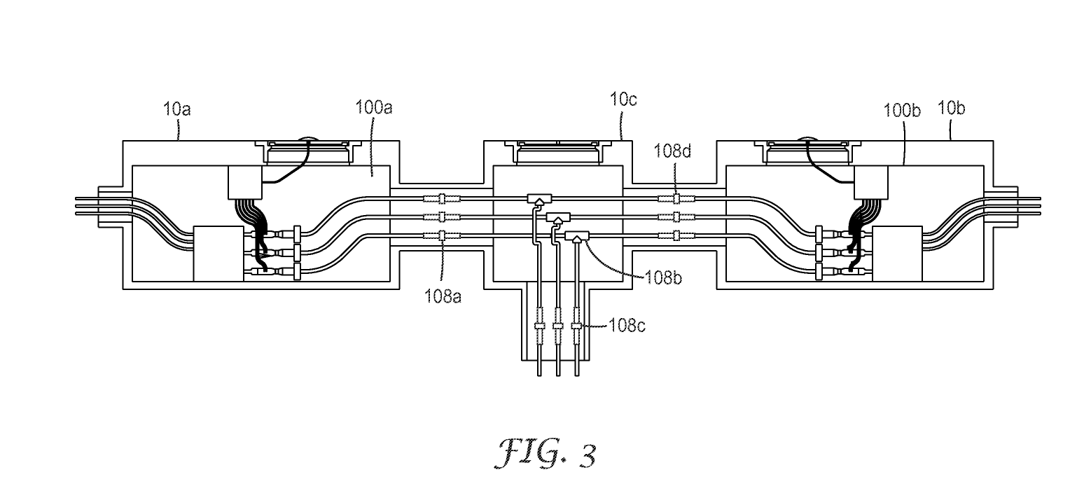

In another aspect of the invention, multiple underground data communication systems can be configured to communicate with monitoring devices and/or equipment located within the underground utility infrastructure outside of a particular vault location. For example, FIG. 3 shows a wireless underground manhole utility infrastructure having a first vault 10a and a second vault 10b interposing a splice enclosure 10c that provides medium/high voltage lines to the vaults. Vault 10a can be implemented with a first underground data communication system 100a (configured in a manner similar to those implementations described above) and vault 10b can be implemented with a second underground data communication system 100b (also configured in a manner similar to those implementations described above). In one example, first underground data communication system 100a is implemented with a Zigbee network. At a desired interval, the RTU or gateway unit of first underground data communication system 100a can monitor a condition of splice 108a, which is located outside of vault 10a, between vault 10a and enclosure 10c. In addition, the RTU or gateway unit of first underground data communication system 100a can monitor a condition of components 108b and/or splices 108c, which are located at or near enclosure 10c. In a similar manner, second underground data communication system 100b can also be implemented with a Zigbee network and can monitor a condition of splice 108d, which is located outside of vault 10b, between vault 10b and enclosure 10c.

In addition, multiple underground data communication systems can be configured to communicate with each other as well as with an above ground network, such as a utility SCADA system. For example, first underground data communication system 100a can communicate directly with second underground data communication system 100b, in addition to communicating with the above-ground network.

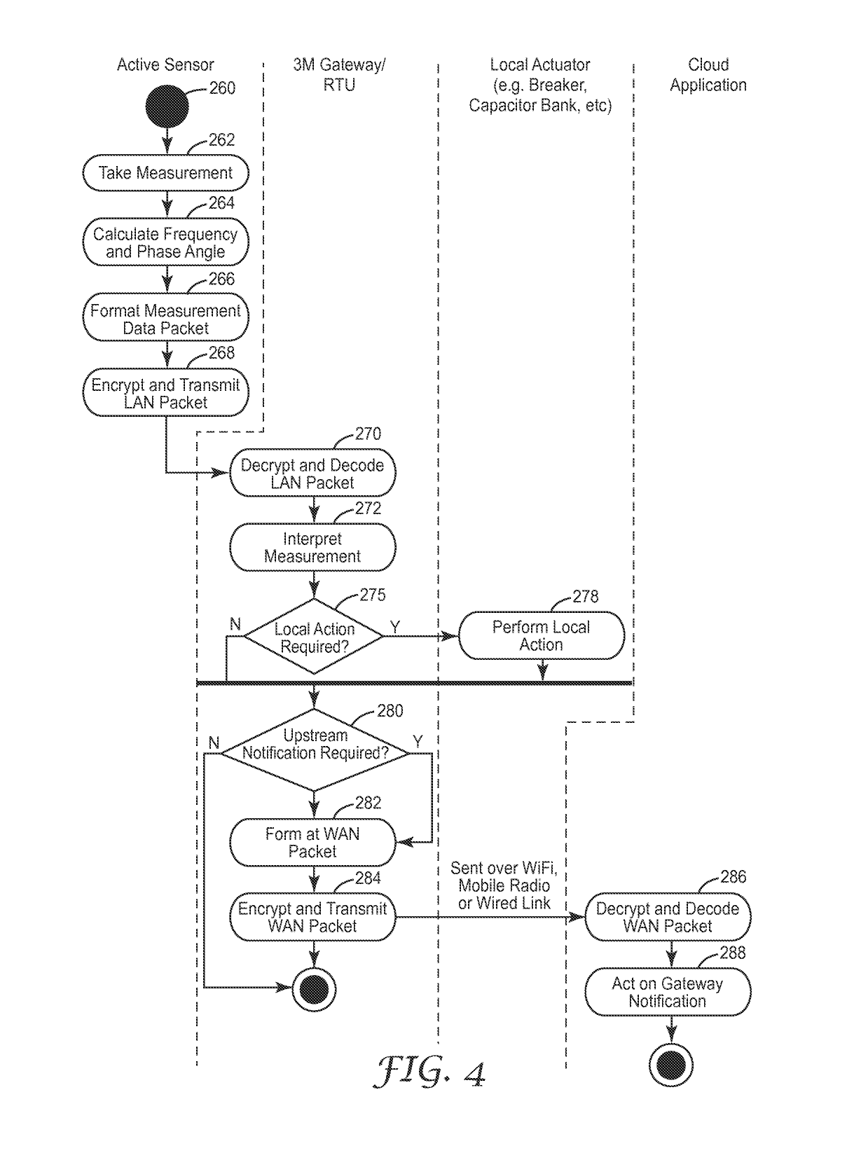

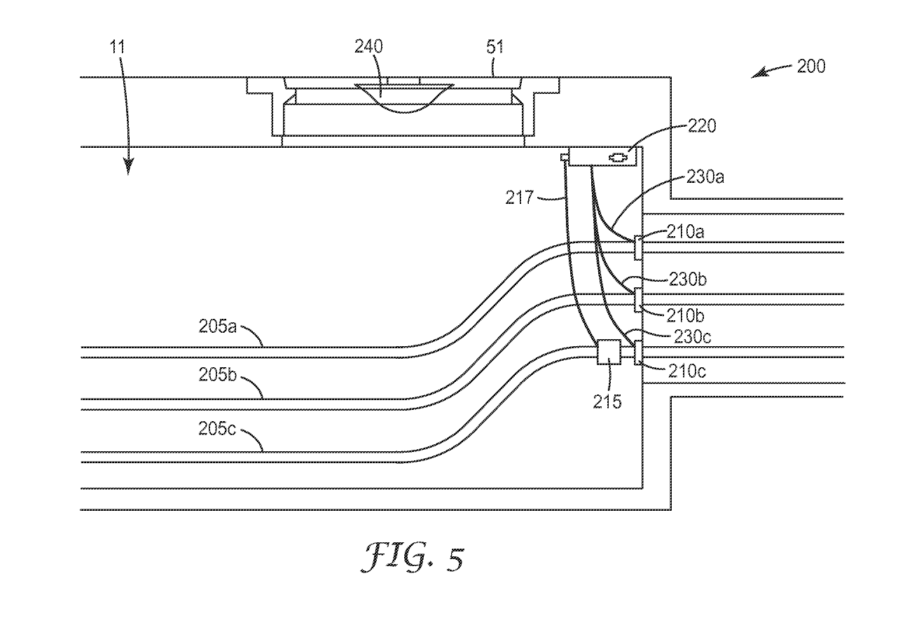

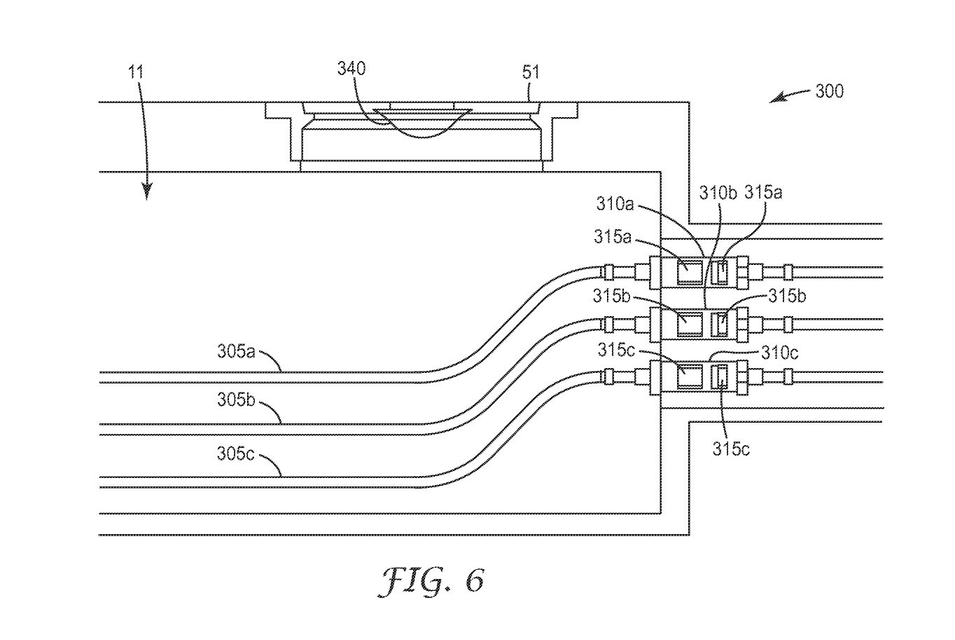

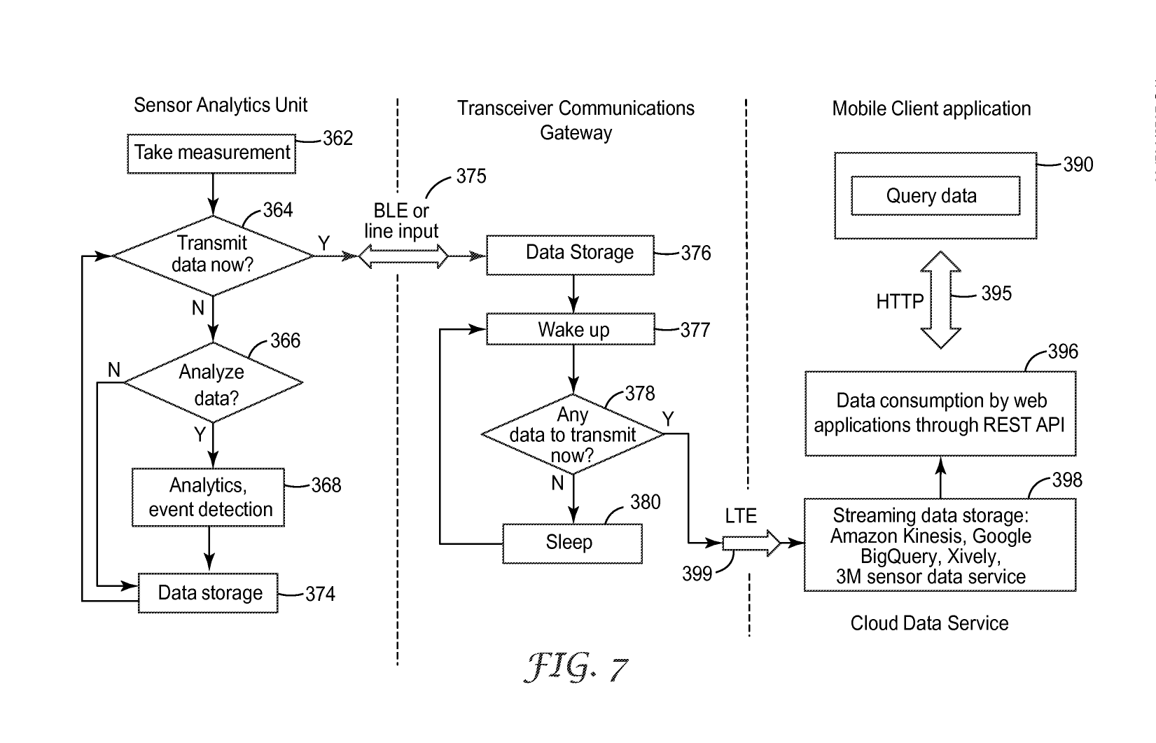

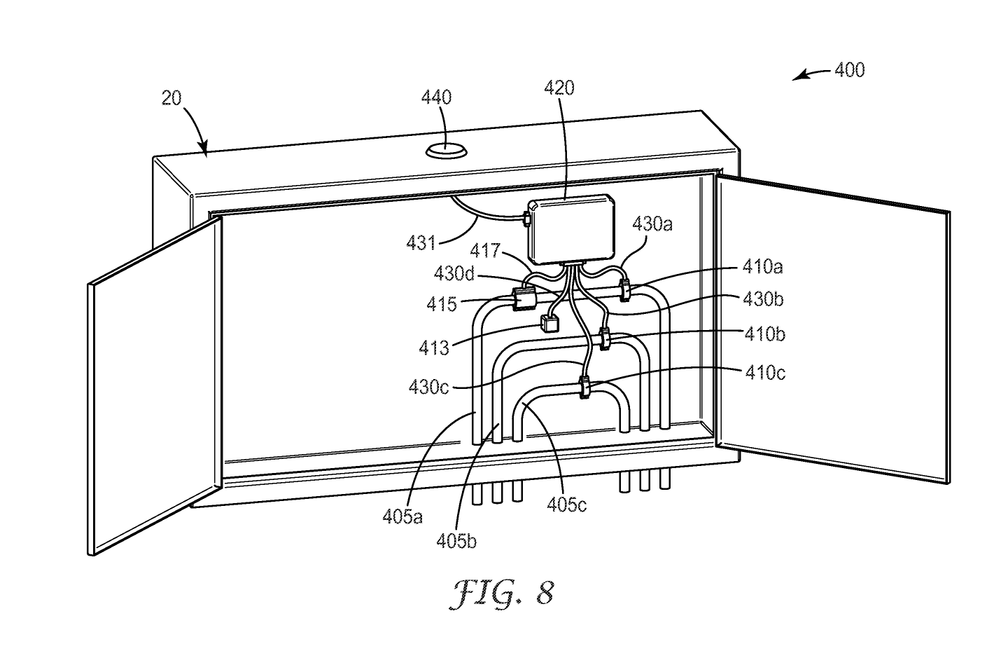

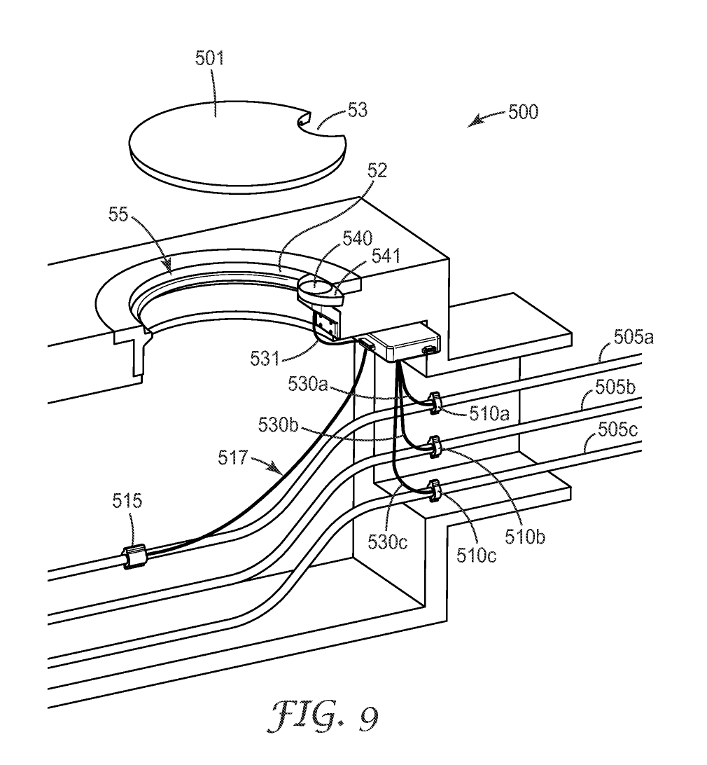

In further detail, FIG. 4 provides an example flowchart 200 illustrating some of the functions of the underground data communication system. As mentioned above, the gateway unit can be a stand-alone unit, it can be incorporated with an RTU or it can be incorporated as part of the transceiver.

In this embodiment, the gateway unit is co-located with the transceiver. A monitoring device, in this example an active sensor 260, which can be configured as a current and voltage sensor of an exemplary sensored termination (such as described previously), takes a measurement (step 262) of real time condition of an electrical line. For example, an analog signal corresponding to the real time condition can be digitized. In this example, the measurement can be communicated to an RTU (either wirelessly or via wire) or it can be processed by the active sensor itself, depending on the type of sensor utilized. Assuming the data is sent to an RTU, the RTU processes the measured signal by calculating the frequency and phase angle (step 264). The measured data is formatted into a measurement data packet (step 266). The data packet is then encrypted and transmitted as a local area network (LAN) packet (step 268). In this example, the LAN is a Zigbee LAN and the RTU includes a Zigbee radio. Alternatively, if an RTU is not utilized, the signal processing can be performed by the monitoring device, which can then communicate the data directly to the gateway or nearest Zigbee radio.

In step 270, the LAN packet is decrypted and decoded by the gateway unit. In step 272, the decoded data is interpreted by the gateway unit. For example, the gateway unit can be uploaded with a library of key faults to provide classification of a particular fault or assignment of a severity level based on preset or downloaded conditions or combinations of existing conditions. Based on the interpretation, the gateway unit determines whether to take a local action (step 275). If a local action is necessary, the gateway communicates a signal to equipment to take action in step 278 (e.g., trip a circuit breaker, turn on/off capacitor bank, etc.).

In addition, the gateway can also determine whether an upstream notification is required in step 280. If yes, the gateway unit can format a wide area network (WAN) packet (step 282) and encrypt and transmit the WAN packet (step 284). The WAN packet can be sent out over WiFi, local radio, etc., as described above. A WAN receiver (e.g., a mobile receiver unit, such as a service technician having a communication device loaded with the appropriate App, or the operations center of the service provider) can receive the WAN data packet, decrypt and decode the WAN packet (step 286). The entity receiving the WAN data packet (e.g., operations center or service vehicle) can then act on the notification from the gateway unit.

In one aspect, this type of communication system allows a utility company to accurately pinpoint an underground fault location, thus saving the time and expense of entering and physically inspecting a multitude of vault locations within the grid. In addition, performing the appropriate local actions can quickly restore service to customers and prevent further damage to the grid itself.

The present invention has now been described with reference to several individual embodiments. The foregoing detailed description has been given for clarity of understanding only. No unnecessary limitations are to be understood or taken from it. All references to right, left, front, rear, up and down as well as references to directions are exemplary only and do not limit the claimed invention. It will be apparent to those persons skilled in the art that many changes can be made in the embodiments described without departing from the scope of the invention. Thus, the scope of the present invention should not be limited to the details and structures described herein, but rather by the structures described by the language of the claims, and the equivalents of those structures.

1. A data communication system, comprising:
a transceiver disposed on an entrance port to an underground vault, the transceiver including a rugged housing the transceiver mounted to a hole formed in the entrance port;
a monitoring device disposed in the vault that provides data related to a real-time condition within the vault; and
a gateway unit that relays the data to the transceiver.

2. The data communication system of claim 1, wherein the monitoring device is coupled to the gateway unit via communication cables.

3. The data communication system of claim 1, wherein the monitoring device communicates with the gateway unit wirelessly.

4. The data communication system of claim 1, wherein the monitoring device comprises a sensor.

5. (canceled)

6. The data communication system of claim 4, wherein the sensor comprises at least one of the following sensors: power, voltage, current, temperature, combustible materials or byproducts of combustion, mechanical strain, mechanical movement, humidity, soil condition, pressure, hazardous atmosphere, liquid flow, leakage, component end-of-life or lifetime, personnel presence, physical state, light level, and vibration.

7. The data communication system of claim 4, wherein the sensor is incorporated in a sensored termination device and is configured to monitor a condition of a power cable.

8. (canceled)

9. The data communication system of claim 1, further comprising a remote terminal unit (RTU) that receives a signal from the monitoring device.

10. The data communication system of claim 9, wherein the RTU includes a wireless network transmitter/receiver.

11. (canceled)

12. The data communication system of claim 1, wherein the gateway unit is disposed in the transceiver unit.

13. (canceled)

14. The data communication system of claim 1, wherein the transceiver unit includes a dual housing that includes an upper body portion and a lower body portion, wherein the upper body portion houses a first antenna portion and a first radio portion, and the lower body portion houses a second antenna portion and a second radio portion.

15. The data communication system of claim 1, wherein the gateway unit performs local analysis and interpretation of data from the monitoring devices.

16. The data communication system of claim 15, wherein the gateway unit interprets monitoring device information to determine at least one of the following environmental conditions: presence of a hazardous gas, moisture, dust, chemical composition, corrosion, and pest presence.

17. The data communication system of claim 1, wherein the gateway unit is configured to perform a local action.

18. (canceled)

19. The data communication system of claim 1, wherein the gateway unit is configured to send aggregated information upstream to another aggregation node or cloud server above ground.

20. The data communication system of claim 19, wherein the aggregated data comprises one or more of periodic status notification and asynchronous alarm notification.

21. The data communication system of claim 1, wherein the gateway unit is configured to respond to messages sent to it by an upstream aggregation node or cloud.

22. The data communication system of claim 1, wherein the entrance port comprises a manhole cover.

23. (canceled)

24. (canceled)

25. The data communication system of claim 1 being a first underground data communication system located at a first vault, further comprising a second underground data communication system located at a second vault, wherein the second underground data communication system communicates via LAN communication with the first underground data communication system.

26. A method of providing condition information about an underground vault, comprising:
providing a transceiver disposed on an entrance port to the underground vault, the transceiver including a rugged housing, at least a portion of the rugged housing extending above the surface of the entrance port;
receiving a LAN data packet corresponding to a vault condition from a monitoring device located within the vault;
interpreting and processing the LAN data packet;
generating a WAN data packet corresponding to either the LAN data packet or the processing of the LAN data packet; and
sending the WAN data packet to an entity outside of the vault.

27. The method of claim 26, wherein an active sensor located in the underground vault takes a measurement of a vault condition to generate measurement data, wherein the measurement signal is processed to generate measured data.

28.-34. (canceled)
